(19) United States
(12) Patent Application Publication
(10) Pub. No.: US 2005/0223749 A1
(43) Pub. Date: Oct. 13, 2005

(54) Method of fabricating an optical fiber preform and drawing of an optical fiber

(76) Inventors: Sung-Koog Oh, Gumi-si (KR); Sung-Jin Kim, Gumi-si (KR)

Correspondence Address: CHA & REITER, LLC, 210 ROUTE 4 EAST STE 103, PARAMUS, NJ, 07652, US

(21) Appl. No.: 10/942,223

(22) Filed: Sep. 16, 2004

(30) Foreign Application Priority Data
Apr. 2, 2004 (KR) 2004-22907

(51) Int. Cl. C03B 37/027

(52) U.S. Cl. 65/412; 65/427; 65/424

(57) ABSTRACT

A method of fabricating an optical fiber preform using an overcladding device and an optical-fiber-drawing method are provided. The overcladding device includes first and second chucks, an annular oxygen-hydrogen burner, a furnace, and a carriage for reciprocating between the first and second chucks positioned on a shelf, and a vacuum pump coupled to one of the chucks. According to the preform-fabricating method, primary and secondary preforms fixed to the first and second chucks are leveled respectively. The primary preform is inserted coaxially into the secondary preform. The secondary preform is pre-heated using the furnace and heated using the oxygen-hydrogen burner, thus softening the preforms. A first end of the secondary preform is sealed by heating the first end using the furnace, and the primary and secondary preforms are collapsed by forming a negative-pressure vacuum state inside the secondary preform through a second end of the secondary preform.

### CLAIM OF PRIORITY

This application claims priority under 35 U.S.C. § 119 to an application entitled “METHOD OF FABRICATING AN OPTICAL FIBER PREFORM AND METHOD OF DRAWING AN OPTICAL FIBER,” filed in the Korean Intellectual Property Office on Apr. 2, 2004 and assigned Serial No. 2004-22907, the contents of which are incorporated herein by reference.

### BACKGROUND OF THE INVENTION

1. Field of the Invention

The present invention relates generally to a method of fabricating an optical fiber preform and, in particular, to a method of fabricating a large-diameter optical fiber preform using an overcladding device.

2. Description of the Related Art

In general, the fabrication of an optical fiber involves producing an optical fiber preform through a rod-in-tube processing or overcladding and drawing the optical fiber having a predetermined diameter from the optical fiber preform. The rod-in-tube processing or overcladding is achieved by inserting a primary preform into a tube-type secondary preform. In addition to the rod-in-tube or overcladding technique, the optical fiber preform can be fabricated using a vapor-phase deposition and modified chemical vapor deposition processes.

According to the deposition methods, the hydrolysis of oxygen (O₂) and chemical gases including SiCl₄ and other dopants, through heating, produces SiO₂ particles called soot. The soot is then deposited on the outer circumferential surface of a preform rod or the inner circumferential surface of a quartz tube. More specifically, in the outer deposition method, the porous preform rod with soot deposited thereon is subject to hydration and sintering in a furnace. As a result, a transparent optical fiber preform is completed. In the inner deposition method, the quartz tube with soot deposited therein is hydrated and sintered in the same manner as in the outer deposition method, thereby completing a transparent optical fiber preform.

The deposition-based fabrication of a large-diameter optical fiber preform, however, has drawbacks in that it tends to lengthen the processing time, decrease product yield, and limit the ability to increase the diameter of the preform.

To overcome the problem of decreased productivity, a large-diameter optical fiber preform is typically fabricated by overcladding. In the overcladding method, a large-diameter optical fiber preform is formed by inserting a primary rod-type preform into a tube-type secondary preform that is formed by a sol-gel process and heating the preforms by a heater. This method is disclosed in detail in U.S. Pat. No. 4,820,322 entitled “Method of and Apparatus for Overcladding a Glass Rod” filed by Jerry, et. al. An oxygen-hydrogen burner is used as the heater.

However, while the outer circumferential surface of the secondary preform softens upon direct heating to decrease its viscosity, the inner circumferential surface is not softened and maintains a constant viscosity. As a result, the temperature differs between the inside and the outside of secondary preform. The non-uniform temperature distribution leads to a distortion of the secondary preform and causes foreign particles to stick in the secondary preform.

Moreover, when the primary preform and the secondary preform are sealed by means of an oxygen-hydrogen burner, water vapor generated from the burner is introduced into the gap between the primary and secondary preforms. The water vapor can be removed due to a vacuum if the secondary preform is thick and collapses slowly. On the contrary, if the secondary preform is thin and collapses fast, the water vapor is absorbed between the primary and secondary preforms. This effect may cause an optical fiber to break during the drawing process from an optical fiber preform.

### SUMMARY OF THE INVENTION

One aspect of the present invention is to provide an optical-fiber-preform-fabricating method for preventing a fiber distortion resulting from irregular temperature distribution and an introduction of moisture in the optical fiber.

Another aspect of the invention is to provide a method of fabricating an optical fiber preform using an overcladding device and an optical fiber drawing method. The overcladding device includes first and second chucks, an annular oxygen-hydrogen burner, a furnace, and a carriage for reciprocating between the first and second chucks positioned on a shelf, and a vacuum pump connected to one of the chucks. The preform fabricating method involves fixing primary and secondary preforms to the first and second chucks that are leveled respectively, and inserting the primary preform coaxially into the secondary preform. The secondary preform is pre-heated using the furnace and heated using the oxygen-hydrogen burner in order to soften its content. A first end of the secondary preform is sealed by heating using the furnace, and the primary and secondary preforms are collapsed by forming a negative-pressure vacuum state inside the secondary preform through a second end of the secondary preform.

### BRIEF DESCRIPTION OF THE DRAWINGS

The above features and advantages of the present invention will become more apparent from the following detailed description when taken in conjunction with the accompanying drawings in which:

FIG. 1 illustrates a method of fabricating an optical fiber preform using an overcladding device according to an embodiment of the present invention;

FIG. 2A is a sectional view of primary and secondary preforms illustrated in FIG. 1, taken along line A-A′;

FIG. 2B is a sectional view of the primary and secondary preforms illustrated in FIG. 1, taken along line B-B′;

FIG. 2C is a sectional view of an optical fiber preform fabricated according to the embodiment of the present invention;

FIG. 3 illustrates the structure of the overcladding device for fabricating the optical fiber preform illustrated in FIG. 1;

FIG. 4 illustrates a method of fabricating an optical fiber preform according to another embodiment of the present invention; and,

FIG. 5 illustrates an optical fiber drawing method according to a third embodiment of the present invention.

### DETAILED DESCRIPTION OF THE INVENTION

Hereinafter, embodiments of the present invention will be described below with reference to the accompanying drawings. For the purposes of clarity and simplicity, well-known functions or constructions are not described in detail as they would obscure the invention in unnecessary detail.

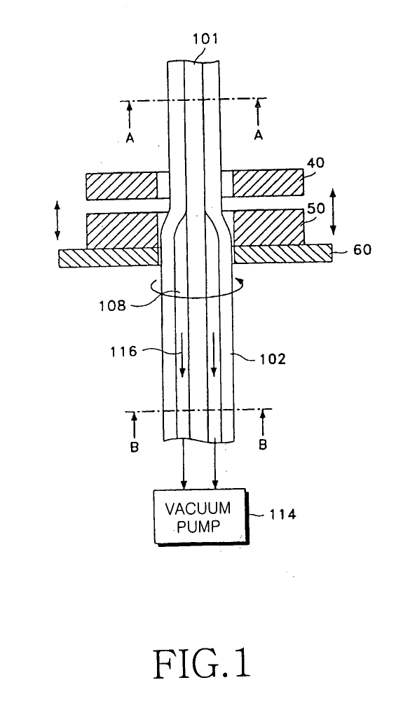

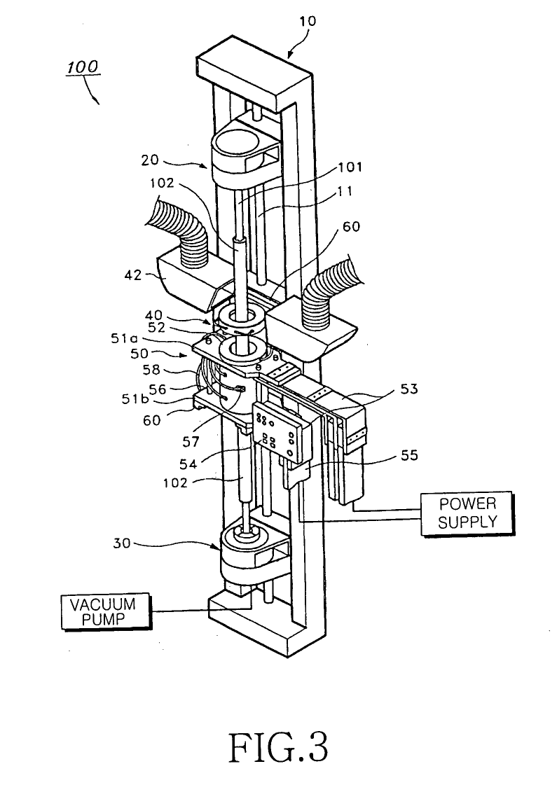

FIG. 1 shows a method of fabricating an optical fiber preform using an overcladding device according to an embodiment of the present invention, and FIG. 3 illustrates the structure of the overcladding device.

Referring to FIGS. 1 and 3, an overcladding device 100 includes first and second chucks 20 and 30, an annular oxygen-hydrogen burner 40, a furnace 50, and a vacuum pump 114. The fabrication of an optical fiber preform using the cladding device 100 involves first leveling, second leveling, overcladding, softening, sealing, and collapsing. The collapsing refers to a process of tightly sticking primary and secondary preforms 101 and 102 to each other by vacuuming the inside of the secondary preform 102 with the primary preform 101 inserted therein at a negative pressure through a second end of the secondary preform 102. The primary preform 101 is a rod formed by outer or inner deposition, and the secondary preform 102 is a quartz tube having an inner diameter of 10 mm. or larger and formed by a sol-gel process or inner deposition.

First, the primary preform 101 fixed to the first chuck 20 is leveled in the first leveling step, and the secondary preform 102 fixed to the second chuck 30 is leveled in the second leveling step.

The primary preform 101 is coaxially inserted into the secondary preform 102 in the overcladding step.

In the softening step, the secondary preform 102 is pre-heated in a furnace 50 and heated by the oxygen-hydrogen burner 40, thus performing softening of the preform.

In the sealing step, a first end of the secondary preform 102 is heated by the furnace 50, thereby sealing the secondary preform 102 onto the primary preform 101.

In accordance with the embodiment of the present invention, the sealing of the secondary preform 102 onto the primary preform 101 inside the secondary preform 102 by heating the first end thereof using the furnace 50 prevents the introduction of moisture produced by the oxygen-hydrogen burner 40 between the primary and secondary preforms 101 and 102.

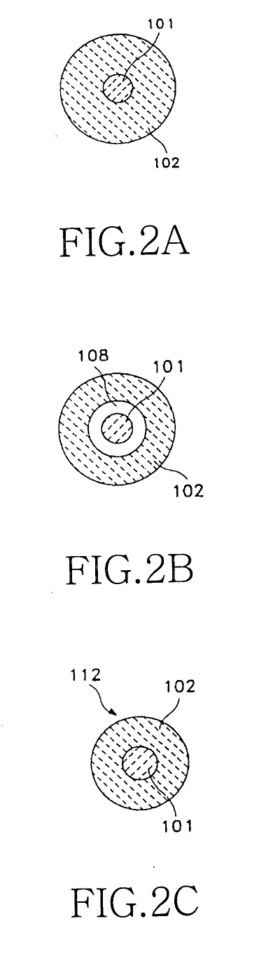

FIGS. 2A, 2B, and 2C are views describing the operation of fabricating a large-diameter optical fiber preform illustrated in FIG. 1. Referring to FIG. 1 through FIG. 3, the overcladding device 100 is used to fabricate a large-diameter optical fiber preform by inserting the primary preform 101 into the secondary preform 102. The device 100 includes a shelf 10, the first and second chucks 20 and 30, the annular oxygen-hydrogen burner 40, the furnace 50, a carriage 60 for reciprocating between the first and second chucks 20 and 30, the vacuum pump 114 coupled to one of the two chucks 20 and 30, a plurality of bus bars 53 for supplying power to the furnace 50, and a power supply coupled to the bus bars 53 via cables 55. The secondary preform 102 can be a synthetic or natural quartz tube.

The shelf 10 may be oriented vertically or horizontally. A means for moving the carriage 60 and a guide rod 11 are mounted on the top surface of the shelf 10, and the first and second chucks 20 and 30 are positioned face to face at both ends of the shelf 10. The carriage 60 makes a reciprocating movement along the guide rod 11.

The primary preform 101 is rotatably fixed to the first chuck 20 and leveled to have a uniform diameter longitudinally. The second preform 102 is fixed to the second chuck 30 and leveled to have a uniform diameter longitudinally. The first and second chucks 20 and 30 support the primary and secondary preforms 101 and 102, respectively, on the shelf 10 in such a manner that the preforms can rotate. More specifically, one end of each of the preforms 101 and 102 is coupled to a dummy tube that is fixed to the first or second chuck 20 or 30. After being leveled, the primary preform 101 is inserted coaxially into the secondary preform 103 with a clearance 108 formed between them.

The furnace 50 is used to heat and pre-heat the second preform 102 having the primary preform 101 therein and includes a graphite-heat emitter inside. The heat emitter emits heat by power received from the power supply. The furnace 50 is maintained at a temperature between 2000 and 2500° C. and forms high-temperature areas in the primary and secondary preforms 101 and 102. By installing a manipulator 54 at the side of the furnace 50, the furnace 50 can be easily operated. A plurality of tubes 58 is coupled to the furnace 50 to inject an inert gas such as Helium (He), Argon (Ar), etc., or a mixture gas of (He+Ar). A conductor flange 51a and a cover flange 52 are assembled onto the top of the furnace 50, and a conductor flange 51b is assembled onto the bottom thereof.

The conductor flanges 51a and 51b are coupled to the bus bars 53 to receive power from the power supply via the cables 55. The conductor flanges 51a and 51b are engaged with each other by the tie bars 56.

The oxygen-hydrogen burner 40 is mounted over the carriage 60 for reciprocating along the length of the secondary preform 102. An extendable duct 42 is positioned over the oxygen-hydrogen burner 40, and the furnace 50 under the burner 40. That is, the duct 42, the burner 40, and the furnace 50 are integrally installed on the carriage 60 and reciprocate along the length of the secondary preform 102.

FIG. 2A illustrates the section of the primary and secondary preforms 101 and 102 illustrated in FIG. 1, taken along line A-A′. Referring to FIG. 2A, the furnace 50 is moved to the first ends of the primary and secondary preforms 101 and 102 by the carriage 60 and heats them, thereby forming high-temperature areas. The heated first ends of the primary and secondary preforms 101 and 102 are sealed onto each other.

Referring to FIG. 2B, the first and second chucks 20 and 30 rotate the primary and secondary preforms 101 and 102, and inert gases are injected into the primary and secondary preforms 101 and 102 via the tubes 58. When the surface of the secondary preform 102 is heated up to 1700° C. by the furnace 50, the oxygen-hydrogen burner 40 is moved to the second ends of the primary and secondary preforms 101 and 102 by the carriage 60. During the movement, the oxygen-hydrogen burner 40 heats the secondary preform 102 at a low temperature. Thus, any foreign materials, which are introduced into the clearance 108 between the primary and secondary preforms 101 and 102, are burnt up and removed.

Referring to FIG. 2C, when the primary and secondary preforms 101 and 102 are softened, the vacuum pump 114 forms a vacuum atmosphere in the secondary preform 102, thereby removing the clearance 108 between the primary and secondary preforms 101 and 102. That is, the vacuum pump 114 is placed inside the secondary preform 102 in a negative-pressure vacuum state, thus sealing the primary and secondary preforms 101 and 102. It also increases the oxygen flow of the oxygen-hydrogen burner 40 from 75 lpm to 150 lpm, thereby collapsing the primary and secondary preforms 101 and 102. Subsequently, the final optical fiber preform is removed from the first and second chucks 20 and 30 and cooled for a predetermined time. Hence, the overcladding of the optical fiber preform is completed.

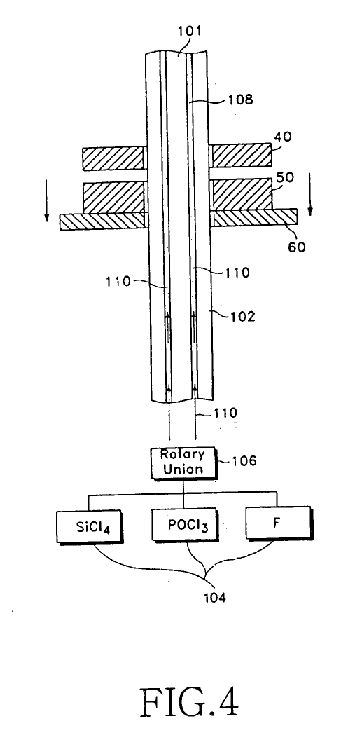

FIG. 4 shows a method of fabricating an optical fiber preform according to another embodiment of the present invention. Referring to FIGS. 3 and 4, the fabrication of an optical fiber preform using the cladding device 100 involves first leveling, second leveling, overcladding, softening, deposition, sealing, and collapsing.

The primary preform 101 fixed to the first chuck 20 is leveled in the first leveling step, and the secondary preform 102 fixed to the second chuck 30 is leveled in the second leveling step.

The primary preform 101 is coaxially inserted into the secondary preform 102 in the overcladding step.

In the softening step, the secondary preform 102 is pre-heated in the furnace 50 and heated by the oxygen-hydrogen burner 40, thus softening the preform.

A deposition layer 110 is formed to match the silica viscosity of the primary preform 101 with that of the secondary preform 101.

In the sealing step, the first end of the secondary preform 102 is sealed.

In the collapsing step, the primary and secondary preforms 101 and 102 are collapsed to tightly contact each other by placing them inside the secondary preform 102 at a negative-pressure vacuum state.

In accordance with the second embodiment of the present invention, glass forming materials 104 are injected into the clearance between the primary and secondary preforms 101 and 102, thereby controlling the viscosities of the primary and secondary preforms 101 and 102.

The overcladding device further includes a rotary union 106 for injecting the glass forming materials 104 between the primary and secondary preforms 101 and 102. To avoid redundancy, the components common to the first and second embodiments will not be described again.

The rotary union 106 mixes the glass forming materials 104 and injects the mixture into the clearance between the primary and secondary preforms 101 and 102 in order to control the silica viscosity between the primary and secondary preforms 101 and 102. Freon, Boron, or POCL₃ alone, or in combination, is used as the glass forming materials 104.

The glass forming materials 104 by which to match the silica viscosity between the primary and secondary preforms 101 and 102 form a deposition layer 108 by heating the primary and secondary preforms 101 and 102 with the forming materials 104 therein using the oxygen-hydrogen burner 40. The surface of the secondary preform 102 is heated at 1800° C. and the reciprocating speed of the oxygen-hydrogen burner 40 is 1.5 to 2 cm/min.

Thereafter, the primary and secondary preforms 101 and 102 are rotated at 20 rpm to 30 rpm by operating the first and second chucks 20 and 30. An inert gas is provided between the primary and secondary preforms 101 and 102. The primary and secondary preforms 101 and 102 are pre-heated for 10 to 30 minutes using the oxygen-hydrogen burner 40 to which 30-lpm hydrogen and 15-lpm oxygen are added.

When the pre-heated primary and secondary preforms 101 and 102 soften with their viscosities dropped, the vacuum pump 114 is operated to form a negative-pressure vacuum state in the clearance between the primary and secondary preforms 101 and 102, thereby sealing them. Finally, an optical fiber preform is completed by collapsing the primary and secondary preforms 101 and 102 using the furnace 50. The optical fiber preform is softened using the oxygen-hydrogen burner 40 and stabilized for a predetermined time.

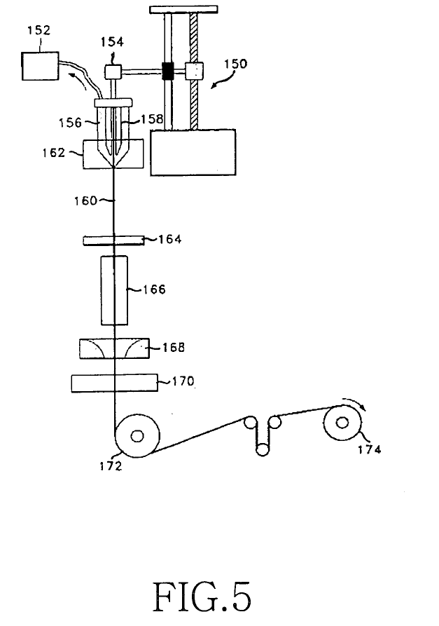

FIG. 5 shows a method of drawing an optical fiber directly without overcladding according to a third embodiment of the present invention. Referring to FIG. 5, the fiber drawing operation involves the formation of an optical fiber preform out of primary and secondary preforms 158 and 156 and drawing an optical fiber from the optical fiber preform.

The formation of the optical fiber preform includes installation of the primary and secondary preforms 158 and 156 in a fiber drawing apparatus, pre-heating of the primary and secondary preforms 158 and 156 for softening, and collapsing.

In the installation step, one end of each of the primary and secondary preforms 156 is sealed, installed to a chuck 154 mounted to a feed module 150 and connected to a vacuum pump 152. That is, the primary and secondary preforms 158 and 156 are leveled respectively and the primary preform 158 is coaxially inserted into the secondary preform 156. Then, the ends of the primary and secondary preforms 158 and 156 are sealed and installed to the chuck 154 at a portion of the feed module 150. The sealed preform ends are connected to the vacuum pump 152.

In the pre-heating step, the primary and secondary preforms 158 and 156 are heated using a furnace 162, thereby forming high-temperature areas. More specifically, the furnace 162 heats the primary and secondary preforms 158 and 156 on the inside, thus forming the high-temperature areas. An inert gas such as Argon is injected into the furnace 162 to prevent high temperature-caused oxidation and the primary and secondary preforms 158 and 156 are heated for 20 minutes or longer, thereby softening the preforms.

In the collapse step, a final optical fiber preform is formed by vacuuming the insides of the softened primary and secondary preforms 158 and 156 and thus collapsing them to tightly contact each other. That is, the vacuum pump 152 forms a vacuum atmosphere at a negative pressure inside the primary and secondary preforms 158 and 156 softened by the furnace 162. Thus, the primary and secondary preforms 158 and 156 are collapsed.

The drawing of an optical fiber involves drawing the optical fiber from the optical fiber preform, cooling the optical fiber, measuring its outer diameter, and coating it with a curing resin.

The optical fiber preform heated by the furnace 162 is drawn using a capstan 172. Thus an optical fiber 160 of a predetermined diameter is drawn. The outer diameter of the optical fiber 160 is measured by means of an outer diameter measurer 164. If the outer diameter is not uniform, the drawing speed of the capstan 172 is selectively controlled, to thereby render the outer diameter uniform. The optical fiber 160 drawn from the optical fiber preform is cooled in a cooler 166 and coated on its outer surface with a UV (UltraViolet)-curing resin such as silicon or acryl in a coater 168. Then, the outer-coated optical fiber 160 is cured in a UV curer 170 and finally wound around a spool 174 by the capstan 172.

As explained above, high-temperature areas are formed on primary and secondary preforms using a furnace and one end of each of the preforms is sealed, thereby preventing the introduction of moisture produced from an oxygen-hydrogen burner into the primary and secondary preforms. Also, the furnace transfers sufficient heat to the secondary preform. Thus, cracks in the secondary preform caused by non-uniform temperature are suppressed. The use of the furnace suppresses the creation of foreign materials, which makes it possible to fabricate a highly-strong optical fiber. Furthermore, the formation of a deposition later by which to match the silica viscosity between the primary and secondary preforms reduces micro bending-incurred loss that might otherwise occur due to the difference in viscosity between the primary and secondary preforms.

While the invention has been shown and described with reference to certain preferred embodiments thereof, it will be understood by those skilled in the art that various changes in form and details may be made therein without departing from the spirit and scope of the invention as defined by the appended claims.

1. A method of fabricating an optical fiber preform using an overcladding device having a shelf, a vacuum pump coupled to one of first and second chucks, an annular oxygen-hydrogen burner, a furnace, and a carriage for reciprocating between the first and second chucks thereon, the method comprising the steps of:
primarily leveling a primary preform coupled to the first chuck;
secondarily leveling a secondary preform coupled to the second chuck;
inserting the primary preform coaxially into the secondary preform;
pre-heating the secondary preform using the furnace and heating the pre-heated secondary preform using the oxygen-hydrogen burner;
sealing a first end of the secondary preform with the primary preform therein by heating the first end of the secondary preform using the furnace; and,
collapsing the primary and secondary preforms by forming a negative-pressure vacuum state inside the secondary preform through a second end of the secondary preform.

2. The method of claim 1, wherein the primary preform is a rod formed by outer or inner deposition.

3. The method of claim 1, wherein the secondary preform is a synthetic or natural quartz tube.

4. The method of claim 3, wherein the secondary preform has an inner diameter substantially larger than 10 mm.

5. The method of claim 1, further comprising the step of removing foreign materials from between the primary and secondary preforms by injecting an inert gas between the primary and secondary preforms.

6. The method of claim 5, wherein the removing step comprises the step of removing foreign material stuck to the outer circumferential surface of the primary preform by means of heat and the inert gas transferred through the inner circumferential surface of the secondary preform.

7. The method of claim 5, wherein the removing step comprises the step of removing foreign material stuck to the outer circumferential surface of the primary preform by means of heat emitted from the furnace or the oxygen-hydrogen burner and the inert gas.

8. The method of claim 5, wherein the inert gas includes one of helium, argon and nitrogen gases.

9. A method of fabricating an optical fiber preform using an overcladding device having a shelf, a vacuum pump coupled to one of first and second chucks, a coupler, and a controller for controlling a flow rate of an oxygen-hydrogen burner and rotation of the chucks, an annular oxygen-hydrogen burner, a furnace, and a carriage for reciprocating between the first and second chucks thereon, the method comprising the steps of:
primarily leveling a primary preform coupled to the first chuck;
secondarily leveling a secondary preform coupled to the second chuck;
inserting the primary preform coaxially into the secondary preform;
pre-heating the secondary preform using the furnace and heating the pre-heated secondary preform using the oxygen-hydrogen burner;
forming a deposition layer for matching silica viscosity between the primary and secondary preforms;
sealing a first end of the secondary preform with the primary preform therein by heating the first end of the secondary preform using the furnace; and,
collapsing the primary and secondary preforms by forming a negative-pressure vacuum state inside the secondary preform through a second end of the secondary preform.

10. The method of claim 9, wherein the step of forming a deposition layer comprises the step of forming the deposition layer by injecting a glass-forming material between the primary and secondary preforms.

11. The method of claim 10, wherein the glass-forming material includes one of SiCl₄, PoCl₃, Freon, and Boron.

12. The method of claim 10, wherein the glass-forming material includes SiCl₄ and PoCl₃.

13. The method of claim 10, wherein the glass-forming material includes SiCl₄, PoCl₃, and Freon.

14. An optical fiber drawing method comprising the steps of:
sealing one of the ends of primary and secondary preforms, installing the sealed primary and secondary preforms to a chuck of a feed module in a fiber-drawing apparatus, and connecting the sealed ends of the primary and secondary preforms to a vacuum pump;
forming high-temperature areas by pre-heating the sealed ends of the primary and secondary preforms by a furnace;
collapsing the primary and secondary preforms by forming a vacuum atmosphere in the softened primary and secondary preforms using the vacuum pump, thereby forming an optical fiber preform having the primary and secondary preforms tightly sealed to each other; and,
drawing an optical fiber from the optical fiber preform, cooling the optical fiber, measuring the outer diameter of the optical fiber, and coating the optical fiber with a curing resin.
